(19) United States
(12) Patent Application Publication
(10) Pub. No.: US 2006/0174291 A1
(43) Pub. Date: Aug. 3, 2006

(54) Playback apparatus and method

(75) Inventors: Motoyuki Takai, Tokyo (JP); Kosei Yamashita, Kanagawa (JP); Yasushi Miyajima, Kanagawa (JP); Yoichiro Sako, Tokyo (JP); Toshiro Terauchi, Tokyo (JP); Toru Sasaki, Tokyo (JP); Yuichi Sakai, Kanagawa (JP)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Sony Corporation, Tokyo (JP)

(21) Appl. No.: 11/336,323

(22) Filed: Jan. 20, 2006

(30) Foreign Application Priority Data
Jan. 20, 2005 (JP) P2005-012535

(51) Int. Cl. H04N 7/173

(52) U.S. Cl. 725/88; 725/89; 725/102

(57) ABSTRACT

The present invention provides a playback apparatus including a receiving unit for receiving entered instruction information for content to be played back; a storage unit for storing the instruction information received through the receiving unit; and a processing unit for reflecting a process corresponding to the instruction information stored in the storage unit on the content at predetermined timing depending on the playback state of the content.

### CROSS REFERENCES TO RELATED APPLICATIONS

The present invention contains subject matter related to Japanese Patent Application JP 2005-012535 filed in the Japanese Patent Office on Jan. 20, 2005, the entire contents of which are incorporated herein by reference.

### BACKGROUND OF THE INVENTION

1. Field of the Invention

The present invention relates to a method and apparatus for playing back various pieces of content, such as a piece of music, video, and the physical motion of an object, e.g., a robot.

2. Description of the Related Art

For example, there are known waveform data playback apparatuses for previously storing a series of waveform data of a music track and playing the stored waveform data to play the music track. In some of the above-mentioned waveform data playback apparatuses, the series of waveform data is divided into musically significant minimum data units, e.g., bars, an operator is assigned to each data unit, and the assigned operators are controlled in real time, thus playing the data units corresponding to the controlled operators in real time to play a piece of music.

Japanese Unexamined Patent Application Publication No. 2000-187484 (Patent Document 1) discloses a technique related to the above-mentioned waveform data playback apparatuses. According to the technique, when changing (shifting) a playback position is instructed in the waveform data playback apparatus, the playback of data is continued up to the next operator and the playback position is then shifted to a position specified by a target operator.

In the use of the technique disclosed in Patent Document 1, when the current playback position in a series of waveform data (audio data) is shifted to another position, unnatural playing caused by the broken rhythm of a music track that is being played can be prevented. Advantageously, if the current playback position is shifted to another position, seamless playing of a music track can be realized.

### SUMMARY OF THE INVENTION

The waveform data playback apparatus disclosed in Patent Document 1 plays back audio data as waveform data. Content playback apparatuses for playing data of various pieces of content, such as audio data and video data, are currently being put into practical use.

Computers, used as control units for various devices, are being downsized and more and more functions are being incorporated into the computers. When the computer is incorporated into a content playback apparatus for playing audio and/or video, the content playback apparatus used in daily life becomes more sophisticated in functionality. Thus, the way of enjoyment of content, such as audio and video to be played, is being extended.

For example, a content creating tool for unprofessional users who do not possess knowledge of music or have a technique for editing audio and/or video is developed. Using this tool, an unprofessional user merely chooses loops, such as music phrases or video scenes, from prepared loops to create a piece of music content including a plurality of music phrases (music loops) or a piece of video content including a plurality of video scenes (video loops) in real time.

In addition, various audio-visual (AV) devices are developed. In one of the AV devices, even when a user does not intentionally press a play button or a stop button, the device senses the motion of the user in a room to automatically start playing content. Another AV device adds variety synchronously with the motion of a user to content that is being played. Additionally, disk jockey (DJ)/video jockey (VJ) tools, portable audio devices and fitness machines for changing music playback speed synchronously with the walking tempo of a user are also developed.

In the apparatuses for playing data of various pieces of content as mentioned above, in addition to a process of shifting a playback position in minimum units, e.g., in bar units, a process of changing various parameters, such as various effects, playback speed, sound volume, tone quality, and picture quality, may be performed during the playback of content.

Assuming that various parameters are changed during the playback of content, when the parameters are changed at timing when a user instructs to change the parameters, a change in content that is being played gives an uncomfortable feeling to the user. Disadvantageously, the entertainment features of the played content may be damaged.

According to the present invention, in consideration of the above disadvantages, it is desirable to provide an apparatus and method for properly and smoothly performing a process of changing various parameters related to content that is being played during the playback of the content without giving an uncomfortable feeling to the user.

According to an embodiment of the present invention, there is provided a playback apparatus including: a receiving unit for receiving entered instruction information for content to be played back; a storage unit for storing the instruction information received through the receiving unit; and a processing unit for reflecting a process corresponding to the instruction information stored in the storage unit on the content at predetermined timing depending on the playback state of the content.

In the playback apparatus according to the embodiment, instruction information related to content to be played back is received though the receiving unit and the instruction information is then stored in the storage unit. The processing unit performs a process corresponding to the stored instruction information on the content at predetermined timing depending on the playback state of the content.

As mentioned above, instruction information entered by a user is temporarily buffered and a process corresponding to the instruction information is reflected on the content at predetermined timing. Thus, when a process of changing various parameters related to content is performed, the content can be played back smoothly and seamlessly.

According to the present invention, in an apparatus for producing (and playing) content in real time, instruction information is simultaneously reflected on the content at a division position, so that the continuity of the content can be held and the smooth and seamless playback of the content can be achieved.

### BRIEF DESCRIPTION OF THE DRAWINGS

FIG. 1 is a block diagram of a content playback apparatus according to an embodiment of the present invention;

FIG. 2 is a diagram explaining the operation of the content playback apparatus according to the embodiment, the operation being performed upon changing a parameter in accordance with an operation input;

FIG. 3 is a diagram explaining an operation input for a parameter regarding the playback of content;

FIG. 4 is a diagram explaining the operation input for the parameter regarding the playback of content;

FIG. 5 is a diagram explaining another example of the way of entering an operation input;

FIG. 6 is a diagram explaining another example of the way of entering an operation input;

FIG. 7 is a conceptual diagram of the content playback apparatus shown in FIG. 1; and

FIG. 8 is a flowchart of a content playback process of the content playback apparatus in FIG. 1.

### DESCRIPTION OF THE PREFERRED EMBODIMENTS

An apparatus and method according to an embodiment of the present invention will be described below with reference to the drawings.

Content Playback Apparatus (Recording and Playback Apparatus)

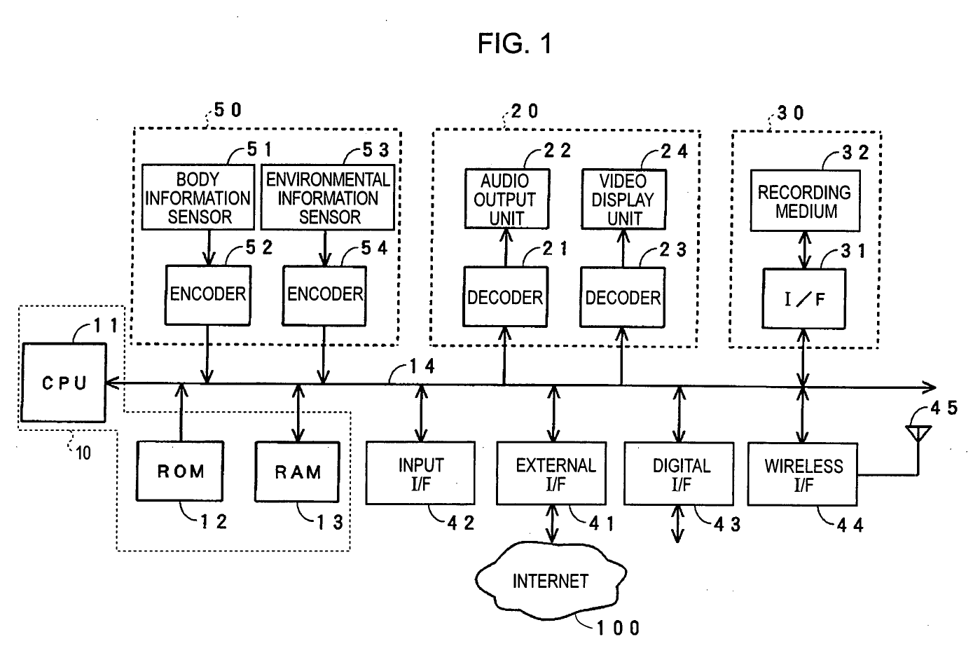

FIG. 1 is a block diagram of a content playback apparatus according to an embodiment of the present invention. Referring to FIG. 1, the content playback apparatus according to the present embodiment includes a control unit 10, an output unit 20, a storage unit 30, an external interface (I/F) 41, an input I/F 42, a digital I/F 43, a wireless I/F 44, a transmitting and receiving antenna 45, and a sensor unit 50.

The control unit 10 includes a microcomputer including a central processing unit (CPU) 11, a read only memory (ROM) 12, and a random access memory (RAM) 13 connected via a CPU bus 14. The control unit 10 controls respective components of the content playback apparatus according to the present embodiment.

The output unit 20 includes an audio decoder 21, an audio output unit 22, a video decoder 23, and a video display unit 24. The audio output unit 22 includes a speaker unit. The video display unit 24 includes a display, such as a liquid crystal display (LCD), a plasma display panel (PDP), an organic electro luminescence (EL) display, or a cathode-ray tube (CRT). The audio decoder 21 generates analog audio signals to be supplied to the audio output unit 22 from audio data to be played. The video decoder 23 generates analog video signals to be supplied to the video display unit 24 from video data to be played. Data to be played will also be called target data below.

The storage unit 30 includes an interface (I/F) 31 and a recording medium 32. As the recording medium 32, various recording media, e.g., a hard disk, an optical disk, a magneto-optical disk, a semiconductor memory, and a flexible disk can be used.

As to the recording media 32, a plurality of recording media of the same type, e.g., hard disks or optical disks, can be used. Alternatively, different types of recording media, e.g., the combination of a hard disk and an optical disk or the combination of an optical disk and a magneto-optical disk, can be used. The recording medium 32 can be built in the apparatus. Alternatively, the recording medium 32 may be detachable from the apparatus, i.e., be exchangeable.

As will be described below, the recording medium 32 can store data to be played, e.g., audio data, video data, audio-visual (AV) data, and data of various pieces of content, such as programs. AV data corresponds to audio and video data to be synchronously played and is content data of, e.g., a movie (video).

The recording medium 32 also stores division information (timing information) designating various division positions (timing positions) in content data, the division information being content attribute information associated with the corresponding content data. Division information is provided every content data, i.e., division information is paired with the corresponding content data. The pair may be recorded in the same recording medium. As will be described later, division information can be downloaded from a server device on the Internet via the external I/F 41. Alternatively, division information may be supplied from an external device through the digital I/F 43 or the wireless I/F 44. In other words, division information can be obtained together with or separately from the corresponding content data.

As mentioned above, the external I/F 41 is used to connect the content playback apparatus according to the present embodiment to the Internet 100. In the content playback apparatus according to the present embodiment, therefore, various pieces of content data, such as audio data, video data, AV data, text data, and other data, can be downloaded over the Internet 100 and be stored on the recording medium 32 through the I/F 31. On the other hand, the content playback apparatus according to the present embodiment can transmit information to a target server device so as to store the information in the server device.

The input I/F 42 is used to receive an operation input from a user. The input I/F 42 includes at least one of various input devices, e.g., a keyboard, a pointing device called a mouse, a touch panel, and similar devices. An operation input received through the input I/F 42 is converted into an electric signal and the converted signal is supplied to the control unit 10. Thus, the control unit 10 controls the content playback apparatus according to the present embodiment in accordance with the operation input from the user.

The digital I/F 43 conforms to, e.g., Institute of Electrical and Electronics Engineers (IEEE) 1394, Universal Serial Bus (USB), or other digital interface. The digital I/F 43 connects to another electronic device through a dedicated line to transmit and receive data, e.g., content data and division information.

The wireless I/F 44 and the transmitting and receiving antenna 45 connect to, e.g., a wireless LAN such that the content playback apparatus can transmit and receive information to/from the wireless LAN through the wireless I/F 44. The content playback apparatus can also receive content data and division information from a wireless LAN system via the wireless I/F 44 and the transmitting and receiving antenna 45.

In the content playback apparatus according to the present embodiment, content data is stored on the recording medium 32 in the storage unit 30 and the corresponding division information is obtained and is stored thereon. As mentioned above, division information, serving as content attribute information, can be externally obtained separately from the corresponding content data through the external I/F 41, the digital I/F 43, or the wireless I/F 44.

Content data and the corresponding division information can be associated with each other using predetermined identification information. Division information associated with target content data can be obtained through various recording media. In some cases, division information is provided such that the information is stored in an area (chunk) different from that for the corresponding content data in a file. In this case, division information can be reliably obtained and used.

According to the present embodiment, the content playback apparatus can transmit content data and division information to other devices via the external I/F 41, the digital I/F 43, and the wireless I/F 44.

The sensor unit 50 includes a body information sensor (body sensor) 51, a body information encoder 52, an environmental information sensor (environmental sensor) 53, and an environmental information encoder 54. The body information sensor 51 includes, e.g., a strain sensor, an acceleration sensor, a shock sensor, a vibration sensor, a direction sensor, a bending sensor, a pressure sensor, an image sensor, a pyroelectric sensor, an infrared radiation sensor, and/or a charge potential sensor. The body information sensor 51 is attached to the user's body or is disposed in the vicinity of the user to detect the motion of the user, transform the detected motion into an electric signal, and output the signal.

In addition, a video camera for capturing an image of the user can be used as the body information sensor. The reason is that video data obtained through the video camera is analyzed to detect the motion of the user. Further, a global positioning system (GPS) may be used as the body information sensor 51. Since the position of the user can be accurately grasped using the GPS, the movement of the user can be grasped.

In this instance, the motion of the user includes walking, vertical body motion, back and forth horizontal head shaking, arm swing, back and forth horizontal torso shaking, and entering and exiting a predetermined area, such as a room. The various motions of respective parts of the user's body, such as hand motions, vertical, horizontal, and back and forth torso motions, leg motions, clapping, and stepping, are also included in the user motion.

Information regarding the position or movement of the user obtained using the GPS, e.g., information describing that the user reaches a target point also indicates the motion of the user. In addition, instructions entered by the user through, e.g., a button, a keyboard, or a percussion type special interface, may be used as information regarding the motion of the user.

The encoder 52 converts detection data supplied from the body information sensor 51 into data in a format compatible with the control unit 10 and functions as an interface for connecting the body information sensor 51 to the control unit 10 in the content playback apparatus.

The environmental information sensor 53 includes, e.g., a temperature sensor, a humidity sensor, a wind force sensor, a lightness sensor, and/or a sound sensor. The environmental information sensor 53 detects information regarding the environment of the user, such as temperature, humidity, wind force, lightness, and/or environmental sound, and outputs the information as electric signals. The encoder 54 converts detection data supplied from the environmental information sensor 53 into data in a format compatible with the control unit 10 and also functions as an interface for connecting the environmental information sensor 53 to the control unit 10 in the content playback apparatus.

Detection outputs (sensor signals) of the body information sensor 51 and the environmental information sensor 53 are supplied to the control unit 10 of the content playback apparatus through the corresponding encoders 52 and 54, respectively. As will be described in detail hereinafter, the control unit 10 can control the playback of target content data in accordance with the sensor signals supplied from the sensor unit 50.

According to the present embodiment, when the content playback apparatus receives an instruction to play target content from the user through the input I/F 42, target content data, such as audio data, video data, or AV data, stored in the recording medium 32 is read through the I/F 31 under the control of the control unit 10. The read content data is played through the control unit 10 using the functions of the output unit 20 to offer the target content to the user.

As mentioned above, division information is associated with each content data. As mentioned above, division information may be recorded together with the corresponding content data in the same file in the same recording medium. Alternatively, division information may be recorded in a file different from that for the corresponding content data in the same recording medium. Alternatively, division information may be supplied from an external device. Alternatively, division information may be obtained from a predetermined server over a network, e.g., the Internet, using identification information to associate the division information with the corresponding content data and be stored on the recording medium 32.

Upon playback of content data, the control unit 10 reads the corresponding division information from the recording medium 32 and temporarily stores the read information in, e.g., a predetermined storage area of the RAM 13 such that the control unit 10 can refer to the corresponding division information according to a progress in playing back the content data.

According to the present embodiment, after starting a process of playing back target content data, the content playback apparatus receives an operation input from the user via the input I/F 42 such that parameters regarding the playback of the corresponding content that is being played can be changed in real time.

In this instance, parameters regarding the playback of content include parameters related to various controls for content, e.g., various effects, tempo, chord progression, sound volume, tone quality, and picture quality, parameters related to a processing path for content data constituting content, and parameters related to a content playback-position shifting process, e.g., fast-forward, fast-rewind, or skip.

As to the parameters regarding the playback of content, the motion of the user's body, user movement information, user positional information, and environmental information, such as temperature, weather, and/or time, are sensed (detected) in addition to positive operation inputs entered by the user received via the input I/F 42 and the detected information can be received as input parameters.

For example, when the walking motion of the user is detected, detected information can be received as parameters to instruct the adjustment of playback tempo of content data, alternatively, parameters to change effects to be applied to target content depending on lightness or temperature.

In the content playback apparatus according to the present embodiment, information serving as input parameters regarding the playback of content, i.e., instruction information corresponding to an operation input (instruction entered by the user) received through the input I/F 42 and/or instruction information corresponding to a sensor input (instruction supplied from a sensor) received via the sensor unit 50 is temporarily stored and held (buffered) in the RAM 13.

Instruction information (corresponding to an operation input or a sensor input) buffered in the RAM 13 is not immediately reflected on content that is being played back. The buffered information is reflected on the content, which is being played back, at predetermined timing based on the corresponding division information. Even when the user instructs to change parameters regarding the playback of content that is being played back, therefore, the content playback apparatus can prevent the user from having an uncomfortable feeling caused by a sudden change in parameters regarding the playback. In other words, playback parameters can be changed properly, smoothly and seamlessly (i.e., without giving an uncomfortable feeling to the user).

Operation upon Changing Parameters in Accordance with Operation Input

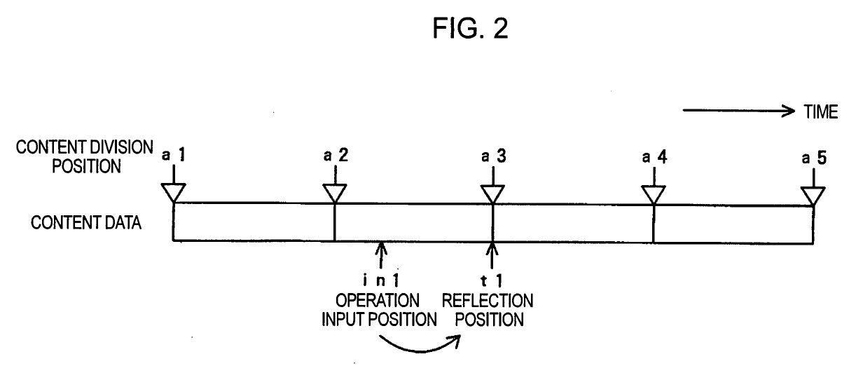

The operation of the content playback apparatus according to the present embodiment upon changing parameters in accordance with an operation input will now be described. FIG. 2 is a diagram explaining the operation of the content playback apparatus according to the present embodiment upon changing parameters in accordance with an operation input. Referring to FIG. 2, a band portion extending along the direction of time shown by the arrow corresponds to content data (target content) to be played back.

Positions a1 to a5 shown by respective triangles on the content data denote division positions based on division information associated with the content data. When the content data is audio data of a piece of music, each division position corresponds to, e.g., a division between bars or a transition between beats. When the content data is video data, each division position corresponds to, e.g., a scene change, a cut change, or a chapter position.

In this instance, in video data, a “scene change” is a change from an indoor scene to an outdoor scene, i.e., a scene itself changes. A “cut change” means a change of view point (of a camera) in the same scene, e.g., a change from a scene as viewed from the front to that as viewed from the side. A “chapter” is a concept for digital versatile discs (DVDs) and means a video division that is arbitrarily settable by a user. If there is no change in terms of video images, a chapter can be set so as to meet the user's preferences. Alternatively, a chapter can be set every designated time unit.

While the content data is played back, when an operation input to instruct the change of parameters for the played content is received at an operation input position in1, the control unit 10 continues the playback process to the division position a3 which is the first division position after the operation input position in1 such that the present parameter settings are not changed (i.e., playback conditions are held without modification).

When the playback position corresponds to the division position a3, the control unit 10 changes the parameters in accordance with instruction information received in the operation input position in1. In this case in FIG. 2, the division position a3 corresponds to a reflection position t1 where the target content reflects a process corresponding to the previously received operation input (instruction information).

Examples of Operation Inputs

Examples of operation inputs for parameters regarding the playback of content in the content playback apparatus according to the present embodiment will now be described. It is assumed that target content data is audio data and an operation input to change a parameter regarding an effect to be applied to target audio data is received through the input I/F 42, such as a mouse and/or a keyboard.

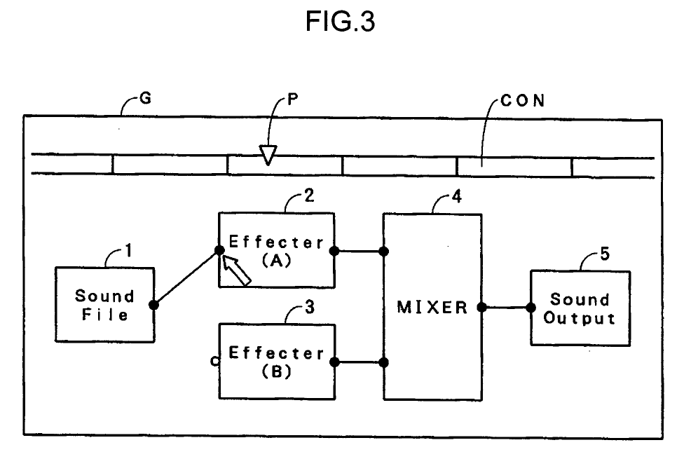

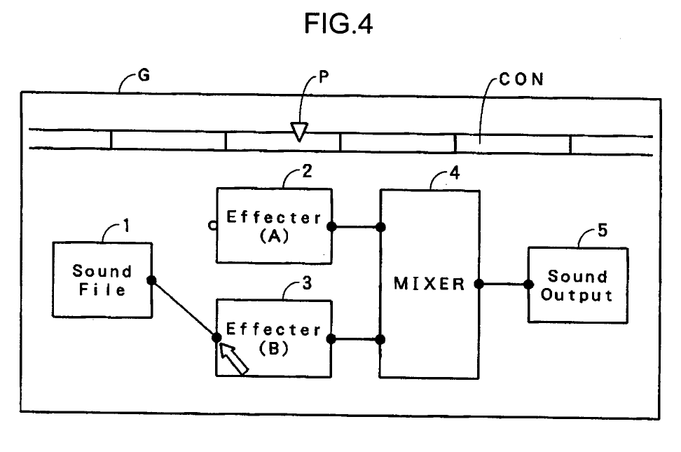

FIGS. 3 and 4 are diagrams explaining an example of an operation input for parameters regarding the playback of content in the content playback apparatus according to the present embodiment. In the content playback apparatus according to the present embodiment, when a predetermined operation input is received via the input I/F 42, a program to apply various effects to audio data, serving as target content data to be played back, is executed and the user can apply a desired (target) effect to the target audio data while confirming images displayed on a display screen G of the video display unit 24.

For example, when the user performs a predetermined input via the input I/F 42 in order to apply a target effect to the target audio data, as shown in FIG. 3, an operation input image is displayed to receive an operation input to apply an effect to the target audio data from the user.

Referring to FIG. 3, a band representing content CON is displayed in the upper portion to show the progress of content playback. An actual playback position in the content CON is designated by a pointer P that moves depending on the playback situation. Each vertical line in the content CON denotes a division position specified by division information associated with the content. The progress is displayed so that the user can confirm the progress of playback. The progress may be omitted if not necessary.

In FIG. 3, signal processing modules (processing units) 1 to 5 are shown by blocks. In this specification, each signal processing module will be referred to as a plug-in hereinafter. FIG. 3 illustrates an example in which a sound file plug-in 1, effecter plug-ins 2 and 3, a mixer plug-in 4, and a sound output plug-in 5 are displayed.

The sound file plug-in 1 functions as a module for reading audio (music) data that is pulse coded modulation (PCM) digital data from a predetermined music file and outputting the audio data every 1/44100 seconds. The effecter plug-ins 2 and 3 each function as a module for applying an effect to received audio data.

In this example, the effecter plug-ins 2 and 3 perform different effect processes. For example, the effecter plug-in 2 performs a pitch shifting process and the other effecter plug-in 3 performs a distortion process. In FIG. 3, therefore, in order to explain that the effecter plug-ins 2 and 3 perform different effect processes, different characters (A) and (B) are assigned to the effecter plug-ins 2 and 3, respectively.

The mixer plug-in 4 functions as a module for combining audio data output from the effecter plug-in 2 with audio data output from the effecter plug-in 3 (i.e., a mixdown process). The sound output plug-in 5 functions as a module for generating an audio signal to be supplied to a speaker unit or headphones.

In the example in FIG. 3, the sound file plug-in 1 is connected to the effecter plug-in 2, the effecter plug-ins 2 and 3 are connected to the mixer plug-in 4, and the mixer plug-in 4 is connected to the sound output plug-in 5.

In this example, therefore, the sound file plug-in 1 reads out audio data from a target audio file and outputs the data as a signal with a sampling frequency of 44.1 kHz to the effecter plug-in 2. The effecter plug-in 2 applies a predetermined effect to the received audio data and supplies the resultant audio data to the mixer plug-in 4.

The mixer plug-in 4 is connected to the effecter plug-in 3 so as to receive audio data therefrom. In this instance, since any input is not supplied to the effecter plug-in 3, a signal at zero level is supplied from the effecter plug-in 3 to the mixer plug-in 4.

The mixer plug-in 4 mixes the received audio data and supplies the resultant audio data to the sound output plug-in 5. The sound output plug-in 5 generates audio signals to be supplied to the speaker unit or headphones from the received audio data and outputs the signals. Consequently, the target audio data with the effect (A) applied by the effecter plug-in 2 can be played back such that the user can listen to music with the effect (A).

The connection between the respective plug-ins in FIG. 3 can be dynamically changed without interrupting the playback of music. Specifically, the user positions a cursor in a position shown by the arrow in FIG. 3 using the mouse, serving as the input I/F 42, and performs a predetermined operation, e.g., the dragging and dropping operation to easily disconnect the sound file plug-in 1 from the effecter plug-in 2 and connect the sound file plug-in 1 to the effecter plug-in 3.

FIG. 4 shows another connection state changed from the connection state in FIG. 3 by the predetermined operation through the input I/F 42. In this state, the sound file plug-in 1 is connected to the effecter plug-in 3. As mentioned above, the connection between the plug-ins can be easily changed using a simple operation, e.g., dragging and dropping.

When the connection state between the plug-ins in FIG. 3 is changed to that in FIG. 4, the change is not immediately reflected on target audio data. When the playback of content reaches the next division position, e.g., the next bar, designated on the basis of division information associated with the content, the change is reflected on the audio data.

In other words, as mentioned above, when the user instructs to change the connection state between the plug-ins using, e.g., the mouse, display information is immediately changed. However, operation input information (instruction information) is held by the control unit 10 in the content playback apparatus and is temporarily stored in a predetermined storage area of the RAM 13 such that the change is not instantly reflected on content that is being played back. When the playback position of the content corresponds to a division position designated based on the corresponding division information, an effect applied to the played content is changed to another one on the basis of the instruction information temporarily stored in the RAM 13.

Until the change is actually reflected on the content after the connection state is changed, in order to inform the user that the playback operation does not reflect the change, for example, the background color of the screen G or the color of the pointer P may be changed to another one, alternatively, the color of each changed plug-in, i.e., each of the sound file plug-in 1 and the effecter plug-ins 2 and 3, may be changed. When the content actually reflects the changed effect, the changed colors of the respective plug-ins simultaneously return to the previous colors.

As mentioned above, display information is immediately changed in accordance with an operation input to instruct the change of a processing path (connection state). When the playback position of content corresponds to a division position designated based on the corresponding division information, the processing path through which the content is processed is actually changed. When an operation input is entered, therefore, an effecter is not immediately changed. The effect is changed at a division position, e.g., a bar. Thus, the effect can be changed at a predetermined division in content such that the user feels comfortable with the content that is being played back.

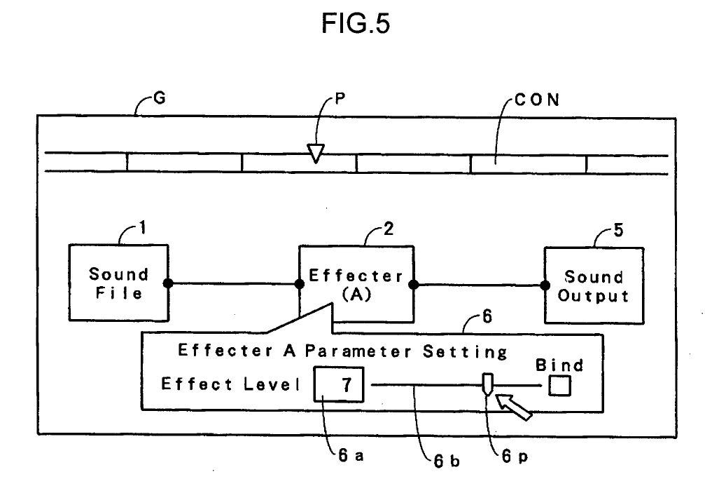

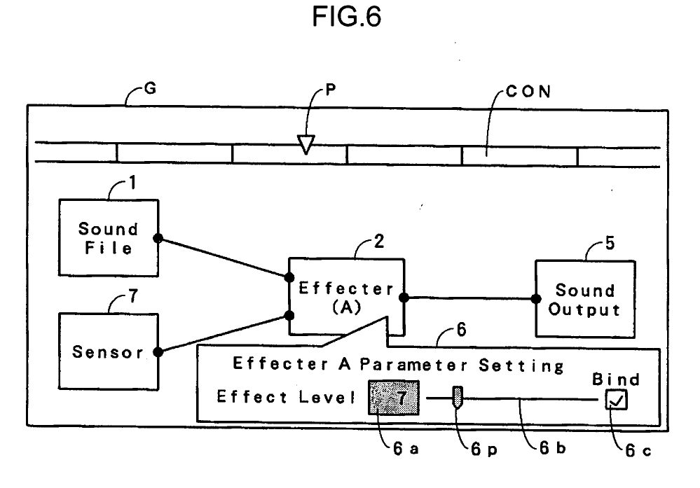

Other examples of operation inputs for parameters regarding the playback of content in the content playback apparatus according to the present embodiment will now be described. FIGS. 5 and 6 are diagrams explaining those examples.

Referring to FIG. 5, in the upper portion of the display screen G of the video display unit 24, the content image CON to show the progress of content playback and the pointer P are displayed in a manner similar to FIGS. 3 and 4. In the display screen G, the sound file plug-in 1, the effecter plug-in 2, and the sound output plug-in 5 are displayed as available plug-ins.

In this case shown in FIG. 5, the sound file plug-in 1, the effecter plug-in 2, and the sound output plug-in 5 are connected. In addition, when the user performs a predetermined operation, e.g., double-clicks on the effecter plug-in 2, an input window 6 for effect parameter setting (e.g., pitch shift scaling, distortion level setting, or reverb delay time setting) is opened.

In this case, the input window 6 for effect parameter setting includes a number entry field 6a and a slide bar 6b. A numeric value is entered into the number entry field 6a, alternatively, a pointer 6p is moved on the slide bar 6b, so that an effect parameter can be changed. When numeric information is entered into the number entry field 6a or the pointer 6p is moved on the slide bar 6b, the control unit 10 does not allow the operation to be immediately valid. The control unit 10 allows the RAM 13 to temporarily store input information so that the input information is reflected on played content at the time when the playback position corresponds to the next division position, e.g., the next bar.

Referring to FIG. 6, in the upper portion of the display screen G of the video display unit 24, the content image CON to show the progress of content playback and the pointer P are displayed in the same way as in FIG. 5. In the display screen G, the sound file plug-in 1, the effecter plug-in 2, the sound output plug-in 5, and a sensor plug-in 7 are displayed as available plug-ins.

In the case shown in FIG. 6, the sound file plug-in 1 and the sensor plug-in 7 are connected to the effecter plug-in 2. The effecter plug-in 2 is further connected to the sound output plug-in 5. When the user performs a predetermined operation, e.g., double-clicks on the effecter plug-in 2, the input window 6 for effect parameter setting (e.g., distortion level setting or reverb delay time setting) is opened in a manner similar to the case in FIG. 5.

In this case, in the input window 6 for effect parameter setting, a checkmark is placed in a bind checkbox 6c, “bind” meaning setting a parameter to an input pin). The bind checkbox 6c is used to set the sensor unit 50 to an input pin of the effecter plug-in 2. In the case of FIG. 6, since the bind checkbox 6c is marked, the sensor unit 50 is set to an input pin (input system) so that the level of the effect parameter varies depending on an output (input information supplied from the sensor unit 50) of the sensor unit 50 corresponding to the sensor plug-in 7.

In the case where the bind checkbox 6c is marked such that the effect level varies depending on an output of the sensor plug-in 7, the effect level cannot be changed by entering a numeric value in the number entry field 6a or moving the pointer 6p on the slide bar 6b. The number entry field 6a and the pointer 6p on the slide bar 6b are displayed in, e.g., gray. Alternatively, notification that the number entry field 6a and the pointer 6p on the slide bar 6b are not available can be provided in another display fashion.

The effect level of the effecter plug-in 2 is automatically changed using an output of the sensor plug-in 7 as a trigger. In this case, a change in effect level is temporarily buffered in the RAM 13 by the control unit 10 and, after that, the change is reflected on target content at the time when the playback position of the target content corresponds to a division position, e.g., a bar.

In this specification, “trigger” means the generation of instruction information or an output. In other words, this means instructing the execution of a process to content that is being played back.

According to the present embodiment, the content playback apparatus includes the body information sensor 51 and the environmental information sensor 53 as the sensor unit 50 corresponding to the sensor plug-in 7. Accordingly, the effect level can be controlled depending on, e.g., a change in the number of steps per unit time of the user or a change in heart rate thereof measured by the body information sensor 51. In addition, the effect level can also be controlled depending on, e.g., a change in lightness or temperature measured by the environmental information sensor 53.

In other words, each of the body information sensor 51 and the environmental information sensor 53 recognizes a pattern or a trigger from sensed information and outputs information to notify the control unit 10 of the pattern or trigger. Consequently, the control unit 10 can control effects to be applied to played content on the basis of output information from the body information sensor 51 and the environmental information sensor 53.

As mentioned above, in the use of output information supplied from the sensor unit 50, a change in effect level is temporarily buffered in the RAM 13 through the control unit 10 and, after that, the change is reflected on content that is being played back at the time when the playback position of the content corresponds to a division position, such as a bar, thus preventing an uncomfortable feeling resulting from a sudden change in effect applied to the content provided to the user through the display 24 or the speaker unit 22.

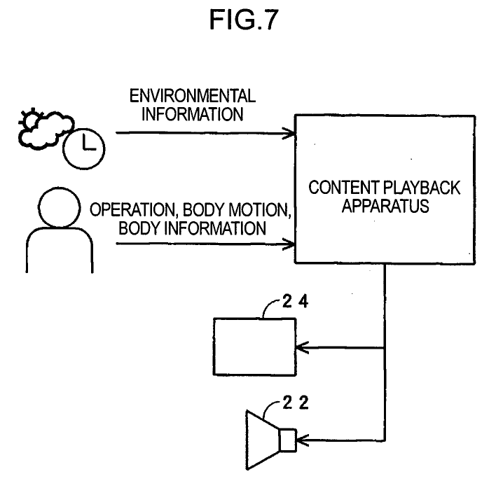

FIG. 7 is a conceptual diagram of the content playback apparatus in FIG. 1 according to the present embodiment. As mentioned above, the content playback apparatus according to the present embodiment can change parameters at timing based on division information associated with content to be played back in response to an operation input received from the user through the input I/F 42, information regarding the user's body motion or body information supplied from the body information sensor 51 of the sensor unit 50, or environmental information supplied from the environmental information sensor 53 of the sensor unit 50.

In the content playback apparatus according to the present embodiment, an instruction or control which will be described below is generated asynchronously with content playback. Therefore, the content playback apparatus can temporarily hold an instruction in response to its trigger and then allow the instruction to be reflected on content at a content division position (division timing) which is graspable based on division information associated with the content.

Specifically, after receiving at least one of the following various triggers, the content playback apparatus can change effects on content that is being played back in a division position which is graspable based on division information associated with the content:

(1) Trigger (instruction information) to change the chord progression of a piece of music, the trigger being output at predetermined time;

(2) Trigger to change a music material, the trigger being output when a user enters a certain place;

(3) Trigger to add a music track, the trigger being output at a predetermined temperature or higher;

(4) Trigger to change the sound volume of a piece of music, the trigger being output when an environmental sound level is equal to or lower than a predetermined value;

(5) Trigger to change effect parameters of a piece of music, the trigger being output when a user walking pattern with a predetermined rhythm is detected;

(6) Trigger to change effects on video, the trigger being output when it is detected that the user sits on a sofa or stands in a room;

(7) Trigger to change the tempo of a piece of music, the trigger being output when the acceleration sensor detects that the user gets into the rhythm of the piece of music;

(8) Trigger to start the playback of another image group, the trigger being output when a predetermined motion pattern of an arm is detected during the playback of a slide show of still images;

(9) Trigger to shift the current phrase to the next phrase in a piece of music, the trigger being output when a predetermined dance motion is detected; and

(10) Trigger to change sound effects on a piece of music, the trigger being output when another person approaching the user is detected through the GPS or short distance wireless communication.

In addition to the above-mentioned cases, a trigger may be output in various cases. When an operation input is directly received from the user, when a change in body information of the user or the motion or movement of the user is detected, alternatively, when a change in environment surrounding the content playback apparatus, e.g., temperature, humidity, lightness, or noise is detected, instruction information (trigger) is generated and is temporarily stored. A process corresponding to temporarily stored instruction information is executed at timing based on division information associated with target content.

Effects on content are not changed just after at least one of the above-mentioned various triggers is received. Accordingly, the user does not know whether any trigger is received. Therefore, in order to inform the user that the trigger is received, e.g., a beep may be generated or a message may be displayed on the screen under the control of the control unit 10. Thus, a more preferable user interface can be realized.

Content Playback Process of Content Playback Apparatus

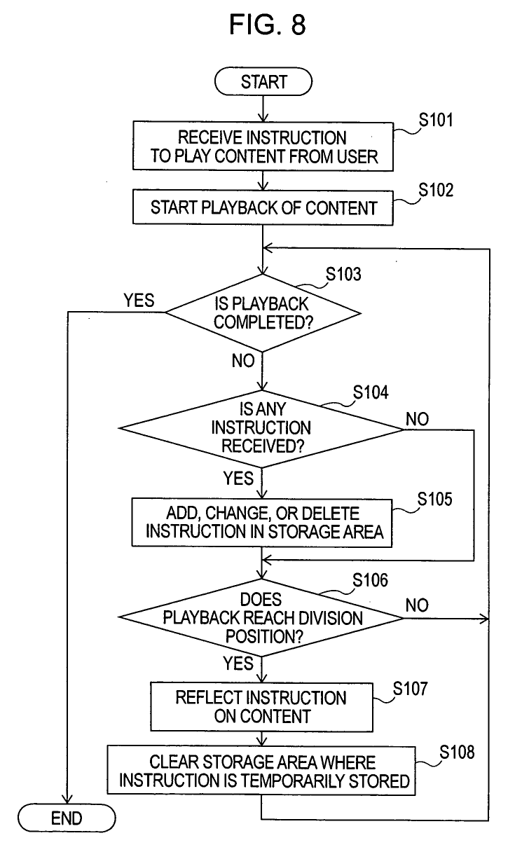

A content playback process executed in the content playback apparatus according to the present embodiment will now be described with reference to FIG. 8. The process shown in FIG. 8 is executed by the control unit 10 of the content playback apparatus when the content playback apparatus according to the present embodiment is turned on.

The control unit 10 receives an instruction to play back content entered by the user through the input I/F 42 (step S101). Then, the control unit 10 controls the storage unit 30 to read content data of the content serving as a playback target and also controls the output unit 20 to start the playback of the content (step S102). In the content playback apparatus according to the present embodiment, upon playback of the content, division information associated with the content is also read out so that the control unit 10 can immediately refer to the division information.

The control unit 10 determines whether the playback of the content is completed (step S103). If YES, the playback process shown in FIG. 8 terminates. If NO in step S103, the control unit 10 determines whether any instruction entered by the user is received through the input I/F 42 or the sensor unit 50 (step S104).

The instruction received in step S104 includes an instruction to control the playback state of content that is being played back, e.g., various effects, tempo, chord progression, sound volume, tone quality, or picture quality, an instruction to change a processing path for content data constituting the content, an instruction to shift the playback position of the content, e.g., fast-forward, fast-rewind, or skip, an instruction to change any of the above-mentioned instructions, or an instruction to delete any of the above-mentioned instructions.

In step S104, if it is determined that any instruction entered by the user is received, the control unit 10 adds, changes, or deletes information corresponding to the received instruction (i.e., instruction information) in, e.g., a predetermined storage area of the RAM 13 as mentioned above (step S105).

In other words, in step S105, when the received instruction entered by the user is a new instruction to adjust the playback state of content, change the processing path, or shift the playback position, i.e., an added instruction, the control unit 10 additionally records instruction information corresponding to the received instruction in the RAM 13. On the other hand, when the received instruction indicates an instruction to change or delete instruction information stored in the RAM 13, the control unit 10 deletes or changes target instruction information in response to the received instruction.

After step S105 or if it is determined in step S104 that any instruction is not received, whether the playback of the content reaches a position (division position) indicated by division information associated with the content is determined on the basis of the division information associated with the playback content (step S106).

In step S106, if it is determined that the playback of the content does not reach a division position, i.e., the playback position does not correspond to a division position, the control unit 10 repeats step S103 and subsequent steps. If it is determined in step S106 that the playback of the content reaches a division position, as mentioned above, the control unit 10 performs a process corresponding to instruction information stored in, e.g., the predetermined area of the RAM 13 to the content that is being played back (step S107).

Therefore, the process corresponding to the entered instruction is not performed at the time when the instruction is received. When the playback of the content reaches a division position based on the corresponding division information, the content is subjected to the process. Then, the control unit 10 clears (initializes) the storage area where the instruction information is temporarily stored (step S108) and repeats step S103 and subsequent steps.

As mentioned above, a process corresponding to an instruction entered by the user is not immediately performed when the instruction is received. The process is performed in a division position specified based on division information associated with content that is being played back. Thus, an uncomfortable feeling caused by a sudden change in playback mode of content that is being played is not given to the user. In other words, various parameters regarding the playback of content that is being played back can be changed properly and smoothly without giving an uncomfortable feeling to the user.

In the content playback apparatus according to the above-mentioned embodiment of the present invention, in addition to the input I/F 42, the sensor unit 50 also has a function of receiving instruction information for content. In other words, in addition to the keyboard and the pointing device, e.g., the mouse, serving as the input I/F 42, the body information sensor 51 and the environmental information sensor 53 can be used as input units. Furthermore, instruction information for content can also be received through the respective I/Fs, e.g., the external I/F 41, the digital I/F 43, and the wireless I/F 44.

The storage unit 30 realizes a storing function. As mentioned above, various recording media can be used. Since a plurality of recording media of the same type or different types can be used, content data and the corresponding division information can be recorded and managed in different recording media, respectively.

In the content playback apparatus according to the above-mentioned embodiment, the control unit 10 and the output unit 20 are operatively associated with each other, thus realizing a processing function of performing a process in accordance with instruction information. In addition, the control unit 10 and the I/F 31 of the storage unit 30 are operatively associated with each other, thus realizing an updating function of adding, changing, or deleting instruction information received through the receiving function.

Only instruction information addition can be performed, or addition and change can be performed. Alternatively, only one of addition, change, and deletion can be performed. In addition, restrictions on users through the use of user IDs can be realized so that a permitted user can change or delete information.

In the above description, division information, serving as timing information associated with content data, can be obtained together with the corresponding content data. Alternatively, only division information can be obtained from a predetermined server device via a network, e.g., the Internet. The way of obtaining division information is not limited to the above examples. For example, division information can be produced by analyzing content data.

For example, when content data is audio data of a piece of music, division information regarding bars is produced on the basis of beats. In addition, division information may be generated such that predetermined instrument playing can be specified. On the other hand, when content data is video data, a scene change point or a cut change point is detected by image pattern matching every frame and the detected points may be used as division information. Alternatively, division information indicating scenes in which a specific character appears can be produced by character recognition processing. Various pieces of division information can be automatically generated by various other methods.

In addition, the user can input division information. For example, while various pieces of content are played back, the user may add division information to each portion that the user likes. When content is audio data of a piece of music, division information can be added to respective parts of the piece of music, e.g., introduction, verse A, refrain, verse B, and interlude thereof. Adding, changing, and/or deleting division information can be performed independently.

In the above description, the content playback apparatus according to the above-mentioned embodiment plays back audio data, video data, and AV data. Data to be played back is not limited to those examples. When a lighting control apparatus for controlling, e.g., home lighting fixtures and a control apparatus for controlling laser illumination used in a concert hall or an event hall are regarded as content playback apparatuses for offering a change in light as content, the present invention can be applied to those apparatuses.

For example, when receiving an instruction to change the intensity of light, the apparatus can change the intensity of light at timing when to change the color of light. For example, when the motion of a robot and that of a fitness machine are regarded as content, the present invention can also be applied to the robot and the fitness machine.

Specifically, assuming that the robot has a function of generating sound and the robot receives an instruction to generate sound from the user, the robot can generate sound each time it performs a predetermined operation. In the case of the fitness machine, when an instruction to increase load on the user is entered, the machine may apply the increased load on the user after a lapse of predetermined time. Alternatively, the fitness machine may start to gradually increase load at proper timing such that the increased load reaches a designated level after a lapse of predetermined time.

In other words, content is not limited to audio and video content. Various pieces of content, such as light and the physical motion of an object, can be controlled. When content indicates light or the physical motion of an object, content data corresponds to a program for controlling the light or the physical motion. A process corresponding to an instruction entered by the user may be executed at predetermined timing, e.g., a point of change in light or motion.

Regarding a slide show provided by sequentially displaying still images using, e.g., a personal computer, assuming that the slide show is offered with a piece of music, the following control can be performed: When an instruction to change a still image (i.e., an image feed instruction) is received, a still image is changed to another one at the head of the next bar of the piece of music which is being played simultaneously with the slide show.

In the above-mentioned embodiment, the use of the content playback apparatus has been described as an example. The present invention is not limited to the embodiment. The present invention can be applied to various playback apparatuses for playing back content, e.g., a personal computer, an apparatus dedicated to AV editing, and a platform device for games. The present invention is not limited to playback-only apparatuses. The present invention can also be applied to various apparatuses each having a content playback function, e.g., recording and playback apparatuses.

In other words, in an apparatus for generating various pieces of content in real time, a parameter change instruction or a configuration change instruction entered by a user is held for predetermined time and the change corresponding to the instruction is reflected on content in a predetermined division position. Thus, content that is being played back can be variously changed properly and smoothly without giving an uncomfortable feeling to the user. Therefore, the continuity of content can be kept. Advantageously, content, such as a music track or a video, can be produced and be seamlessly played back in real time.

It should be understood by those skilled in the art that various modifications, combinations, sub-combinations and alterations may occur depending on design requirements and other factors insofar as they are within the scope of the appended claims or the equivalents thereof.

1. A playback apparatus comprising:
receiving means for receiving entered instruction information for content to be played back;
storage means for storing the instruction information received through the receiving means; and
processing means for reflecting a process corresponding to the instruction information stored in the storage means on the content at predetermined timing depending on a playback state of the content.

2. The apparatus according to claim 1, further comprising:
updating means for performing at least one of addition, change, replacement, and deletion of the instruction information stored in the storage means in response to new instruction information when the new instruction information is received through the receiving means.

3. The apparatus according to claim 1, wherein the receiving means includes at least one of an information input device, a body sensor, and an environmental sensor, the information input device including a keyboard and/or a pointing device, the body sensor detecting body motion of a user and a change in body information, the environmental sensor detecting a change in environment including temperature, weather, direction, geography, lightness, environmental sound, and/or time information.

4. The apparatus according to claim 1, wherein the processing means performs as the process at least one of a content control process of controlling effects, tempo, chord progression, sound volume, or picture quality, a changing process of changing a processing path for content data constituting content, and a content playback-position shifting process involving fast-forward, fast-rewind, or skip.

5. The apparatus according to claim 3, wherein when the receiving means includes the body sensor, the receiving means includes as the body sensor at least one of an acceleration sensor, a shock sensor, a global positioning system, a direction sensor, a bending sensor, a pressure sensor, a video signal analyzer, a pyroelectric sensor, an infrared radiation sensor, and a charge potential sensor.

6. The apparatus according to claim 1, wherein
the content to be played back is associated with timing information to designate the predetermined timing, and
the processing means specifies timing to reflect a process corresponding to the instruction information on the content based on the timing information associated with the content.

7. The apparatus according to claim 1, further comprising:
obtaining means for externally obtaining timing information to designate timing to reflect a process corresponding to the instruction information on the content, wherein
the processing means specifies timing to reflect a process corresponding to the instruction information on the content based on the timing information obtained through the obtaining means.

8. The apparatus according to claim 1, further comprising:
generating means for generating timing information to designate the predetermined timing from the content to be played back, wherein
the processing means specifies timing to reflect a process corresponding to the instruction information on the content based on the timing information generated by the generating means.

9. The apparatus according to claim 6, further comprising:
change receiving means for receiving change information related to the timing information; and
changing means for adding, changing, or deleting the timing information based on the change information received through the change receiving means.

10. The apparatus according to claim 1, wherein the content includes a piece of music, a video, a change in light, and physical motion of an object including a robot.

11. The apparatus according to claim 10, wherein when the content is a piece of music, the timing information presents division information specifying a bar or bars of the piece of music and musically distinctive change points including a start of a refrain, an end thereof, a start of singing, and an end thereof.

12. The apparatus according to claim 10, wherein when the content is a video, the timing information presents distinctive change points including scene change points, cut change points, and chapter change points.

13. A playback method comprising the steps of:
receiving entered instruction information for content to be played back;
storing the received instruction information; and
reflecting a process corresponding to the stored instruction information on the content at predetermined timing depending on a playback state of the content.

14. A playback apparatus comprising:
a receiving unit for receiving entered instruction information for content to be played back;
a storage unit for storing the instruction information received through the receiving unit; and
a processing unit for reflecting a process corresponding to the instruction information stored in the storage unit on the content at predetermined timing depending on a playback state of the content.
